(19) United States
(12) Patent Application Publication
(10) Pub. No.: US 2007/0273433 A1
(43) Pub. Date: Nov. 29, 2007

(54) FLOATING VOLTAGE SOURCE

(76) Inventor: Jon S. Choy, Austin, TX (US)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/420,050

(22) Filed: May 24, 2006

(51) Int. Cl. G05F 1/10; G05F 3/02

(52) U.S. Cl. 327/541

(57) ABSTRACT

A floating voltage source circuit that provides a floating voltage. The floating voltage source circuit includes a feedback current path and a floating voltage current path, where the floating voltage provided by the floating voltage current path is dependent upon a current of the feedback current path. The current through the feedback current path is controlled by the reference voltage.

### BACKGROUND OF THE INVENTION

1. Field of the Invention

This invention relates in general to electronic circuitry and more specifically to a floating voltage source for electronic circuitry.

2. Description of the Related Art

Floating voltage sources can be utilized to provide a relatively precise voltage drop in an electronic circuit. Such floating voltage sources may be utilized to add or subtract voltage to a regulated voltage source or input to place the total voltage in an operable voltage range of a circuit. For example, such a floating voltage source may be used to place a voltage in an operable voltage range of one or more transistors of a circuit for proper operation. Such floating voltage sources may be used in voltage regulators where the regulated voltage is outside the operating ranges of the control circuitry. Another example of where a floating voltage source may be used is to adjust the input voltages of an operational amplifier (op amp) to place the input voltages within the operational range of the transistors of the operational amplifier.

Some floating voltage sources have been referred to as “floating batteries” in that the operation of the floating voltage source may have battery like voltage addition or voltage subtraction characteristics.

One problem with some floating voltage sources is that to get a precise voltage source, they require the generation of a precise current. To generate a precise current, precise voltages and resistances are needed. Obtaining precise resistances may be problematic due to manufacturability issues and varying operating temperatures.

What is needed is an improved floating voltage source.

### BRIEF DESCRIPTION OF THE DRAWINGS

The present invention may be better understood, and its numerous objects, features, and advantages made apparent to those skilled in the art by referencing the accompanying drawings.

FIG. 1 is a circuit diagram of a negative voltage regulator circuit according to one embodiment of the present invention.

FIG. 2 is a circuit diagram of a floating voltage source according to one embodiment of the present invention.

FIG. 3 is a circuit diagram of a negative voltage regulator circuit according to another embodiment of the present invention.

FIG. 4 is a circuit diagram of a floating voltage source according to another embodiment of the present invention.

The use of the same reference symbols in different drawings indicates identical items unless otherwise noted.

### DETAILED DESCRIPTION

The following sets forth a detailed description of a mode for carrying out the invention. The description is intended to be illustrative of the invention and should not be taken to be limiting.

FIG. 1 is a circuit diagram of a negative voltage regulator according to one embodiment of the present invention. Regulator 101 includes a floating voltage source 107 for providing a regulated negative voltage V_{NEG} (e.g. −1.0V) at node 117.

Regulator 101 includes a negative voltage charge pump 103 that pulls node 117 to a negative voltage when a signal to the enable input (EN) is asserted. When the signal is not asserted, pump 103 does not pull node 117 to a negative voltage, instead, the voltage at node 117 is pulled to ground as load capacitor 113 discharges. Regulator 101 includes an enable control circuit for controlling the enable signal. The control circuit includes a comparator 105 having an output that produces a signal that is buffered by inverters 109 and 111 before being provided to the enable input of pump 103. The inverting input of comparator 105 is coupled to a reference voltage circuit and the non inverting input is coupled to node 117 via a floating voltage source 107. Pump 103 includes a clock input (CLK) that is coupled to an oscillator (not shown). In one embodiment, the oscillator may be used to drive multiple pumps similar to pump 103.

In the embodiment shown, comparator 105 is utilized to turn on charge pump 103 when the voltage of node 117 rises above a specific voltage level (as determined by Vref). Turning on charge pump 103 lowers the voltage of node 117. In one embodiment, the voltage of node 117 is regulated to −1 V.

Comparator 105 has power inputs connected to a VDD supply rail (VDD) and connected to a ground rail, which are both at higher voltages than −1V. Also, Vref is at a positive voltage (e.g. 0.6V) which is also above −1V. In order for comparator 105 to be used to regulate the voltage of node 117, regulator 101 includes a floating voltage source 107 that adds a constant voltage level (e.g. 1.6 V) to the voltage of node 117 so that the voltage of node 115 is within the operating range of comparator 105. Accordingly, by adding 1.6 volts by floating voltage source 107 to the negative voltage of node 117, comparator 105 can assert the enable signal if the voltage of its non inverting input (node 115) rises above the 0.6 V of Vref to pull the voltage of node 117 lower. Accordingly, comparator 105 can be used to regulate a negative voltage even though is power inputs are connected to voltage supplies at higher voltages. In some embodiments, a shunt regulator (not shown) may be added to regulator 101 to turn off pump 103 if the voltage of node 117 goes below a particular threshold.

In the embodiment shown, the voltage of floating voltage source 107 that is added to node 117 is controlled by a reference voltage V_{RV}. In the embodiment shown, the voltage of floating voltage source 107 is proportional to V_{RV} by a multiplier (N) where N can be 1.0 or another number.

The negative voltage of node 117 may be utilized in a number of different devices. In one example, the negative voltage of node 117 is applied to the gates of a FLASH memory cell to inhibit leakage current. In other embodiments, node 117 is coupled to a well of a transistor to create a body effect.

In other embodiments, other types of negative voltage sources could be used in place of charge pump 103 and capacitor 113 to provide a negative voltage. Also in other embodiments, other types of feedback control circuitry (e.g. feed back circuitry with op amps) could be used to provide a feedback signal to control charge pump 103 (or other negative voltage source). Also in other embodiments, the output of comparator 105 may be provided back to the enable input of pump 103 by a circuits having other configurations.

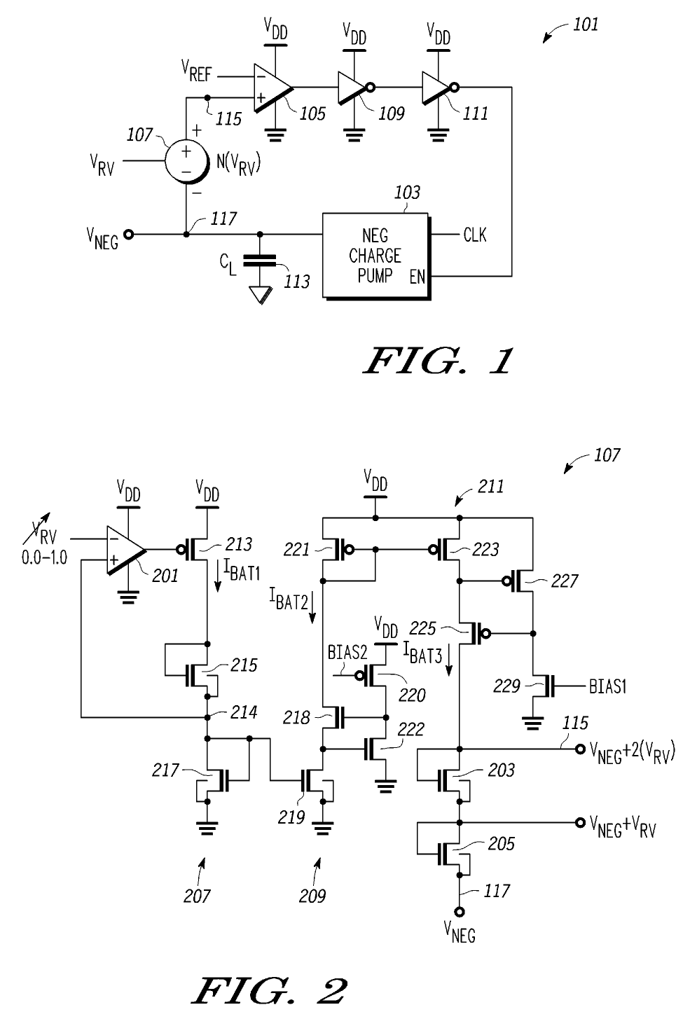

FIG. 2 is a circuit diagram of one embodiment of floating voltage source 107. In the embodiment shown the, the floating voltage between nodes 117 and 115 is provided by the voltage drop of transistors 203 and 205. In the embodiment shown, transistors 203 and 205 are field effect transistors (FET) of an N-type conductivity (N-channel) having a common bulk source connection. In one embodiment, the bulk source connection of transistors 203 and 205 is implemented with FETs having a triple well. However, in other embodiments, other types of floating voltage elements (e.g. other types of transistors, resistors, or diodes) may be used.

The voltage drop across transistors 203 and 205 is dependant upon the current flowing through its current electrodes (e.g. the source and drains of a FET). In the embodiment shown, transistors 203 and 205 are located in a current path 211 that includes P-type conductivity FET transistors 223 and 225. Transistor 223 is utilized as a current control element for controlling the current (I_{BAT3}) of path 211, and thereby controlling the voltage between nodes 115 and 117.

Transistor 223 has an control electrode (gate electrode for a FET) that is connected to current path 209. Current path 209 flows from a VDD power rail (VDD) to ground through transistors 221, 218, and 219. The voltage at the gate of transistor 223 is dependent upon the amount of current (I_{BAT2}) flowing through current path 209. The amount of current flowing through current path 209 is controlled by the voltage at the gate of transistor 219. Because the gate of transistor 219 is connected to node 214, the amount of current flowing through current path 209 is dependent upon the voltage at node 214.

Node 214 is located in current path 207, which is located between VDD and ground. Also included in path 207 is P-channel transistor 213, N-channel transistor 215, and N-channel transistor 217. The amount of current (I_{BAT1)}) flowing through current path 207 is controlled by the conductivity of transistor 213.

In the embodiment shown, the gate of transistor 213 is connected to operational amplifier 201. Operational amplifier 201 includes a non inverting input connected to node 214 and an inverting input connected to a reference voltage (V_{RV}), which is the embodiment shown is variable during the operation of the circuit within a range (e.g. between 0 to 1.0V in the embodiment shown). Amplifier 201 is configured to provide its output at a voltage level to control the conductivity of transistor 213 such that the voltage of node 214 is equal to V_{RV}.

In one embodiment, transistors 215, 217, 219, 203, and 205 have the same width and length. Also in one embodiment, transistors 221 and 223 have the same width and length. Accordingly, the currents of I_{BAT1}, I_{BAT2}, and I_{BAT3} will equal each other. Thus, by controlling the voltage of the gate of transistor 213 such that the voltage of node 214 equals V_{RV} in the embodiment shown, the voltage drop across transistor 203 and the voltage drop across transistor 205 will each equal V_{RV} in that transistors 203 and 205 are the same size as transistor 217. However, in other embodiments, where different sizes of transistors are used, the voltage drop across transistors 203 and 205 may be proportional to V_{RV} at ratios other than 1.0. Accordingly, the amount of floating voltage provided between nodes 117 and 115 can be controlled by controlling the voltage of V_{RV}.

Source 107 includes a voltage clamp circuit to limit the voltage drop across transistor 223. In the embodiment shown, the voltage clamp circuit includes transistor 227, transistor 229, and transistor 225. Transistor 229 is biased with a bias voltage (BIAS 1) such that it produces a current through transistors 229 and 227 that limits the voltage drop across transistor 223, wherein transistor 225 absorbs the voltage drop between transistor 223 and node 115.

Source 107 also includes a second voltage clamp circuit to limit the voltage drop across transistor 219. This second clamp circuit includes transistors 218, 222, and 220. Transistor 220 is biased at a voltage (BIAS 2) that produces a current through transistors 220 and 222 that limits the voltage drop across transistor 219, wherein transistor 218 absorbs the voltage drop between transistor 219 and 221.

One advantage that may occur by using feed back of a separate current path from the current path with the floating voltage element is that it provides for the use of a reference voltage to control the floating source voltage where the reference voltage is relative to a fixed potential (e.g. ground) as opposed to a floating potential. Accordingly, with some embodiments, the amount of floating voltage provided may be controlled by a reference voltage relative to a fixed potential.

Controlling the floating voltage with a reference signal may allow in some embodiments, the ability to provide a floating voltage that is relatively independent of temperature and process conditions.

One advantage that may occur with using an intermediate current path (e.g. path 209) between the feed back current path (e.g. path 207) and the floating source path (e.g. path 211) is that it may facilitate the matching of current through the feed back current path with the current through the floating source current path even if those paths operate between different voltage ranges. For example, path 207 operates between VDD and ground whereas path 211 operates between VDD and V_{NEG}.

In another embodiment, a floating voltage source circuit would include only two current paths (a feed back current path and a floating source current path) where the output of the current control circuit (e.g. operational amplifier 201 in FIG. 2) would be coupled to an input of the current control elements (e.g. transistors 213 and 223 of FIG. 2) of both paths to control the current through both paths.

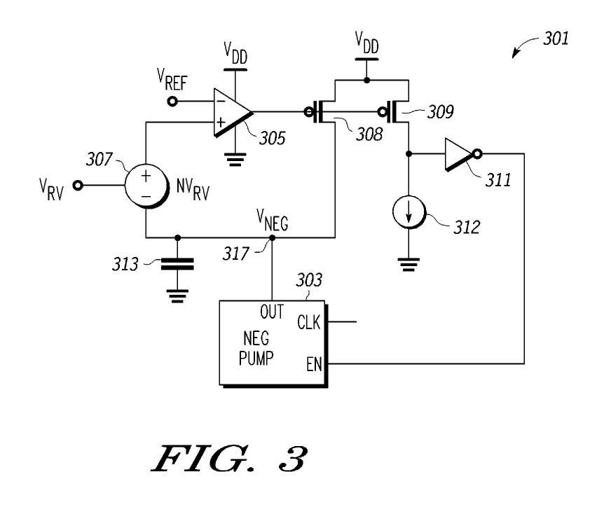

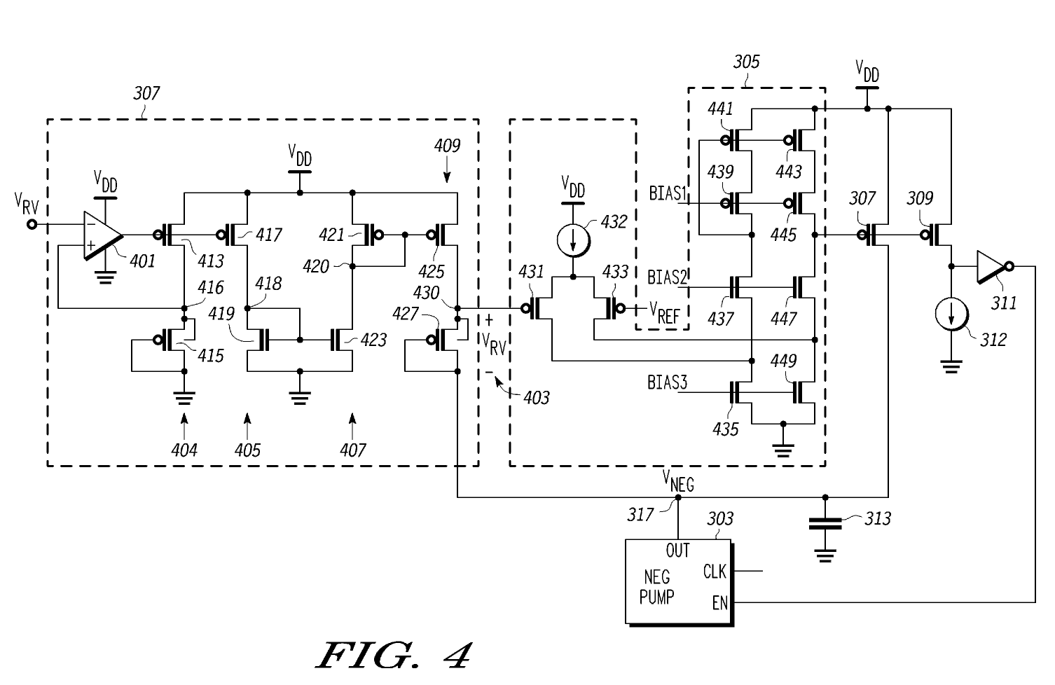

FIG. 3 is a circuit diagram of a negative voltage regulator circuit according to another embodiment of the present invention. Regulator 301 is similar to regulator 101 except that it utilizes a different type of voltage control circuit for controlling the voltage of node 317. Charge pump 303 operates similarly to charge pump 103. Capacitor 313 is connected to node 317.

The output of comparator 305 is connected to the gates of transistors 308 and 309. When the voltage of node 317 rises above V_{REF}+NV_{RV}, then comparator 305 makes transistor 309 non conductive, which asserts the signal into the enable input (EN) of pump 303 to activate charge pump 303 to pull the voltage of node 317 lower. Inverter 311 has an output connected to the enable input and an input connected current source 312.

Regulator 301 also includes a shunt regulated load (transistor 308) that becomes more conductive when as node 317 goes lower in voltage. Transistor 308 is a relatively weaker transistor than transistor 309 such that it dose not over load pump 303. Accordingly, transistor 308 becomes more conductive to prevent the voltage of node 317 from going below the targeted negative voltage when charge pump 303 is activated.

Regulator 301 also includes floating voltage source 307 to provide a floating voltage (NV_{RV}) to the voltage of node 317 that is proportional to V_{RV}.

FIG. 4 is a more detailed circuit diagram of one embodiment of the circuit of FIG. 3. Specifically, FIG. 4 shows more details of one embodiment of floating voltage source 307 and of comparator 305.

In the embodiment of FIG. 4, floating voltage source 307 includes four current paths: current path 404, current path 405, current path 407, and current path 409. Current path 409 includes a transistor 425 for controlling the current in current path 409 and a transistor 427 for providing the floating voltage source. In the embodiment shown, the floating voltage source is the drop across transistor 427. In the embodiment shown, transistor 427 has a common bulk source connection.

The gate of transistor 425 is connected to node 420 of current path 407 such that the amount of current flowing though current path 409 is dependent upon the voltage of node 420. The voltage of node 420 is dependent upon the flow of current through current path 407.

Current path 407 includes transistor 421 and transistor 423 that are connected in series between VDD and ground. The amount of current through path 407 is controlled by the conductivity of transistor 423. The gate of transistor 423 is connected to a node 418 of current path 405. Accordingly, the amount of current through path 407 is controlled by the voltage at node 418, which is controlled by the voltage through current path 405.

Current path 405 includes transistor 419 and transistor 417. The gate of transistor 417 is connected to the output of operational amplifier 401, which controls the conductivity of transistor 417, thereby controlling the current through current path 405.

Operational amplifier 401 has an inverting input coupled to a reference voltage (V_{RV}) (which in one embodiment can be variable during the operation of regulator 301). Operational amplifier 401 includes a non inverting input coupled to node 416 of current path 404. The output of amplifier 401 also is connected to transistor 413 to control the current flowing through feed back current path 404. Thus, amplifier 401 is configured to control the current of current path 404 such that the voltage at node 416 is equal to V_{RV}. The voltage at node 416 is the voltage drop across transistor 415.

Accordingly, the current through path 404 is used to provide feed back for amplifier 401 for controlling the current through path 405, which controls the current through path 407, which controls the current through path 409, which controls the floating voltage added to the voltage of node 317.

In the embodiment shown, the widths and lengths of transistor 413, 417, 421, and 425 are equal. Also in the embodiment shown, the widths and lengths of transistors 415 and 427 are equal and the widths and lengths of transistors 419 and 423 are equal. Accordingly, the voltage drop across transistor 427 is equal to V_{RV}. However, in other embodiments, the widths and lengths of the transistors shown in FIG. 4 may be of different dimensions from each other such that the voltage drop across transistor 427 is proportional to V_{RV} at another multiplier other than 1.0.

In the embodiment shown, the floating voltage is the voltage drop across only one transistor (403) in path 409. However, in other embodiments, source 307 includes a greater number of transistors in current path 409 for providing the floating voltage.

Compared with the embodiment of source 107 shown in FIG. 2, the embodiment of source 307 as shown in FIG. 4 includes two intermediate current paths (405 and 407) between the feedback current path (404) and the floating voltage current path (409) as opposed to one intermediate current path. Providing the extra current path, may in some embodiments, allow for the use of non isolated transistors (e.g. 427) to be used to provide the floating voltage.

In the embodiment shown in FIG. 4, comparator 305 includes P-channel conductivity type transistors 431, 433, 441, 443, 439, and 445 and N-channel conductivity type transistors 435, 449, 437, and 447. Transistors 439 and 443 are biased with a first bias voltage (BIAS1), transistors 437 and 447 are biased with a second bias voltage (BIAS2), and transistors 435 and 449 are biased with a third biased voltage (BIAS3). The gate of transistor 431 is connected to node 430 and the gate of transistor 433 is connected to V_{REF}. Comparator 305 also includes a current source 432.

In other embodiments, source 307 may include voltage clamp circuits in paths 405, 407, and 409 similar to those shown in FIG. 2.

Although FIGS. 2 and 4 shown floating voltage source circuits that include FET transistors, floating voltage source circuits in other embodiments may be made or include other types of devices (e.g. bi-polar transistor, resistors, diodes). For example, the floating voltage source may be provided in some embodiments, by a voltage drop across a bi-polar transistor(s), diode(s), and/or resistor(s)).

While particular embodiments of the present invention have been shown and described, it will be recognized to those skilled in the art that, based upon the teachings herein, further changes and modifications may be made without departing from this invention and its broader aspects, and thus, the appended claims are to encompass within their scope all such changes and modifications as are within the true spirit and scope of this invention.

What is claimed is:

1. A circuit comprising:
a first current path including a first control element;
a current control circuit having a first input to receive a reference voltage and a second input to receive a feedback voltage from the first current path, the current control circuit having an output to provide a control signal to the first current control element based on the reference voltage and the feedback voltage;
a second current path, the second current path including a floating voltage element and a second current control element, the floating voltage element providing a floating voltage dependent upon current flowing through the second current path, the second current control element having an input to receive a voltage that is dependent upon the output of the current control circuit.

2. The circuit of claim 1 wherein the first current control element includes a first transistor and the second current control element includes a second transistor, wherein the first transistor and the second transistor are of a same conductivity type.

3. The circuit of claim 1 wherein the first current control element and the second current control element each include field effect transistors.

4. The circuit of claim 1 wherein the floating voltage element includes a transistor.

5. The circuit of claim 4 wherein the transistor is characterized as a field effect transistor.

6. The circuit of claim 5 wherein the transistor has a common bulk source connection.

7. The circuit of claim 1 further comprising:
a third current path including a third current control element, the third current control element having an input to receive a voltage dependent the output of the current control circuit, the input of the second current control element is coupled to receive a voltage of the third current path.

8. The circuit of claim 7 further comprising:
a fourth current path including a fourth current control element, wherein the input of the third current control element is coupled to receive a voltage of the fourth current path, wherein the voltage of the fourth current path is dependent upon the output of the current control circuit.

9. The circuit of claim 8 wherein the fourth current path includes a fourth current control element having an input coupled to the output of the current control circuit.

10. The circuit of claim 7 wherein the first current control element includes a first transistor and the third current control element includes a second transistor, wherein the first transistor is of a different conductivity type than the second transistor.

11. The circuit of claim 7 wherein the third current control element includes a field effect transistor having a common bulk source connection.

12. The circuit of claim 1 comprising:
a third current path including a third current control element, the third current control element having an input to receive a voltage from the first current path, wherein current flowing through the third current path is dependent upon the voltage of the first current path.

13. The circuit of claim 12 wherein the input of the second current control element is coupled to receive a voltage of the third current path, wherein the voltage of the third current path is dependent upon current flowing through the third current path.

14. The circuit of claim 1 wherein the first current control element includes a first transistor and the floating voltage element includes a second transistor, wherein the first transistor and the second transistor are of opposite conductivity types.

15. The circuit of claim 1 wherein the floating voltage is proportional with the reference voltage.

16. The circuit of claim 1 wherein the reference voltage is variable during an operation of the circuit, wherein the floating voltage varies in proportion with a variation of the reference voltage during an operation of the circuit.

17. The circuit of claim 1 wherein the current control circuit includes an operational amplifier having an inverting input to receive the reference voltage and a non inverting input to receive the feedback voltage.

18. The circuit of claim 1 further comprising:
a voltage clamp circuit coupled to the second current path to limit a voltage drop across the second current control element.

19. The circuit of claim 1 wherein the floating voltage element includes a node coupled to a first voltage source, wherein the first current path is coupled for current to flow from a second voltage source to a third voltage source, wherein the first voltage source is at a voltage below the second voltage source and the third voltage source during operation of the circuit.

20. The circuit of claim 1 wherein the floating voltage element includes a first transistor and a second transistor connected in series.

21. A voltage regulation circuit comprising:
a voltage source circuit having an output to provide a voltage, the voltage source circuit having an input to receive a control signal wherein the voltage of the output of the voltage source circuit is dependent upon the input of the voltage source circuit;
a voltage control circuit having an output coupled to the input of the voltage source circuit, a first input of the voltage control circuit is coupled to a first reference voltage, the voltage control circuit having a second input, the voltage control circuit has an operating range between a first operating voltage and a second operating voltage, wherein the output of the voltage source circuit is at a lower voltage than the first operating voltage and the second operating voltage during an operation of the circuit;
a floating voltage source having a first node coupled to the output of the voltage source circuit and a second node coupled to the second input of the voltage control circuit, the floating voltage source providing floating voltage between the first node and the second node, the floating voltage source comprising:
a first current path including a first current control element;
a current control circuit having a first input to receive a second reference voltage and a second input to receive a feedback voltage from the first current path, the current control circuit having an output to provide a control signal to the first current control element based on the second reference voltage and the feedback voltage;
a second current path, the second current path including a second current control element, the first node is coupled to a first location of the second current path and the second node is coupled to a second location of the second current path, the floating voltage between the first node and the second node is dependent upon current flowing through the second current path, the second current control element having an input to receive a voltage that is dependent upon the output of the current control circuit.
